(19) United States
(12) Patent Application Publication
(10) Pub. No.: US 2005/0172036 A1
(43) Pub. Date: Aug. 4, 2005

(54) METHOD FOR TRANSMITTING DATA IN A MULTI-CHIP SYSTEM

(76) Inventors: Yao-Jen Liang, Chang-Hua Hsien (TW); Ming-Yang Chao, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/709,551

(22) Filed: May 13, 2004

(30) Foreign Application Priority Data
Jan. 29, 2004 (TW) 093102047

(51) Int. Cl. G06F 3/00

(52) U.S. Cl. 710/1

(57) ABSTRACT

A multi-chip system has at least a host chip and at least a slave chip. The slave chip informs the host chip of data needed to be transmitted. When informed by the slave chip the host chip informs the slave chip to start to transmit the data, and when informed by the host chip the slave chip starts to transmit the data to the host chip.

### BACKGROUND OF INVENTION

1. Field of the Invention

The present invention relates to a method for transmitting data in a multi-chip system, and more particularly, to a method of transmitting data between a host chip and a slave chip.

2. Description of the Prior Art

As integrated circuit (IC) technologies are under rapid development, it is very common to see electronic systems having a multi-chip system frame. A multi-chip system normally includes at least a host chip engaged in controlling the operation of the system, and at least a slave chip engaged in executing servo control or detecting some particular signals. Normally, the host chip is a digital chip, and the slave chip is an analog chip. However, this arrangement is adjustable and not a restriction to the multi-chip system.

Take an optical disk drive for example. The task of the slave chip is to execute the servo control of the optical disk drive, and detect some particular signals, such as a tracking servo signal, a focusing servo signal, a tray open signal, a tray close signal, a disc blank signal, and a disc defect signal, etc. It is necessary for the host chip to obtain the above-described signals detected by the slave chip while controlling the operation of the optical disk drive.

According to conventional technologies, a common way for the host chip to obtain the signals is described as follows. The slave chip detects the states of some signals periodically, and stores these states in a register. As long as the states of the signals have changed, the slave chip will update the register. In addition, the host chip has to check the values held in the register actively and periodically so as to determine if the states of the signals have changed.

There are disadvantages in the conventional method, and one of these disadvantages is that the processor's resources are wasted if the host chip checks the register frequently. For ensuring the multi-chip system's performance, the frequency of checking the values held in the register cannot be low. However, this wastes the resources of the processor in the conventional multi-chip systems.

Besides, another conventional method for the host chip to obtain the states of signals is to implement pin pairs to each signal source needed to be monitored between the host chip and the slave chip so as to fulfill the purpose of data transmission. However, the quantity of the pin pairs increases as the number of signal sources need to be monitored increases, and this would cause an increase in the system cost.

### SUMMARY OF INVENTION

It is therefore one of the many objectives of the present invention to provide a method for transmitting data in a multi-chip system for solving the above problems.

According to the claimed invention, a method for transmitting data in a multi-chip system is disclosed. The multi-chip system includes at least a host chip and at least a slave chip. The method includes the following steps: (a) the slave chip informing the host chip of data needed to be transmitted; (b) when being informed by the slave chip, the host chip informing the slave chip to start transmitting the data; and (c) when being informed by the host chip, the slave chip starting transmitting the data to the host chip.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a multi-chip system according to the present invention.

FIG. 2 is a flowchart of a preferred embodiment of the present invention.

FIG. 3 is a waveform diagram illustrating an example of voltage changes of the four pin pairs.

### DETAILED DESCRIPTION

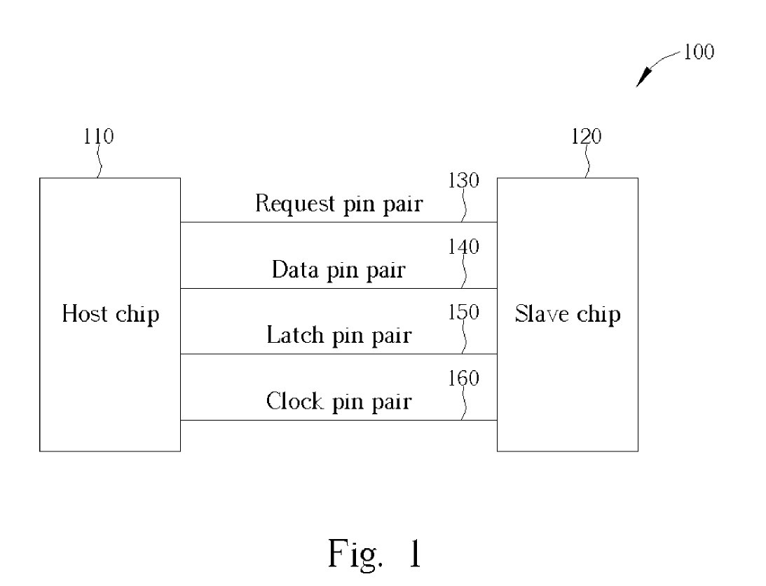

FIG. 1 is a schematic diagram of a multi-chip system 100 according to the present invention. As shown in FIG. 1, the multi-chip system 100 includes a host chip 110 and a slave chip 120 electrically connected to each other via several pin pairs, where each pin pair includes a pin of the host chip 110 and a pin of the slave chip 120. In FIG. 1 four pin pairs, which are respectively a request pin pair 130, a data pin pair 140, a latch pin pair 150, and a clock pin pair 160, are illustrated. It is worth noting that other pin pairs connected between the host chip 110 and the slave chip 120 can be used where necessary, and quantity of the pin pairs is not restricted to four as shown in FIG. 1.

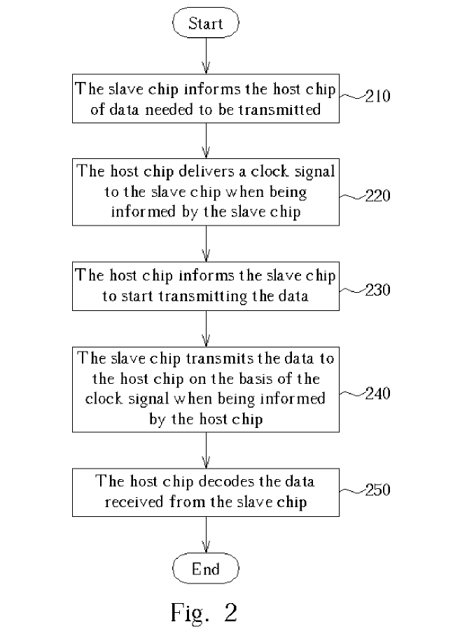

Please refer to FIG. 2 (with reference to FIG. 1 as well). FIG. 2 is a flowchart of a preferred embodiment of the present invention. Details of each step in FIG. 2 are described as follows.

Step 210: If the slave chip 120 has any information to be delivered to the host chip 110, the slave chip 120 actively alters the voltage on the request pin pair 130 so as to inform the host chip 110 of data to be transmitted.

Step 220: The host chip 110 checks the voltage on the request pin pair 130 periodically, when the host chip 110 detects a voltage change of the request pin pair 130, or the host chip 110 is triggered by a positive edge or a negative edge of the voltage on the request pin pair 130, the host chip 110 delivers a clock signal to the slave chip 120 via the clock pin pair 160 (the clock signal is used for synchronizing).

Step 230: The host chip 110 informs the slave chip 120 to transmit data by altering the voltage on the latch pin pair 150.

Step 240: The slave chip 120 transmits the data to the host chip 110 via the data pin pair 140 on the basis of the clock signal of the clock pin pair 160.

Step 250: The host chip 110 decodes the data received from the slave chip 120 on the basis of the clock signal.

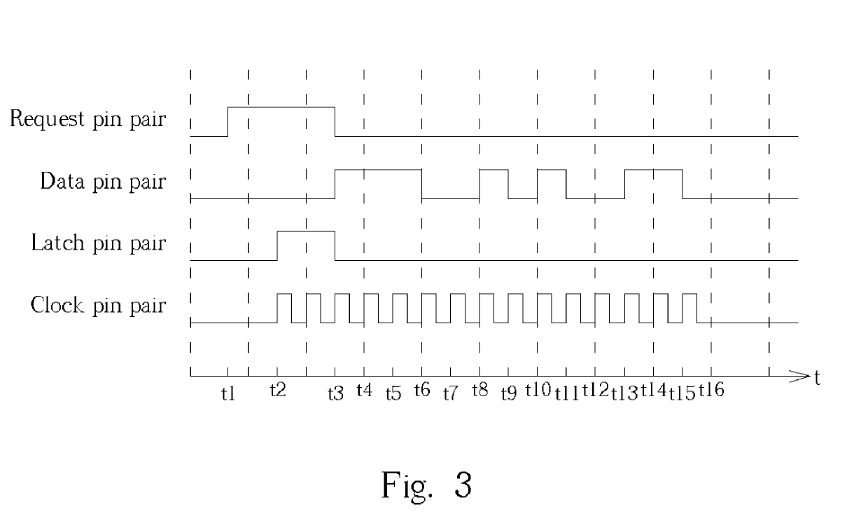

FIG. 3 is a waveform diagram illustrating an example of voltage changes of the four pin pairs. As shown in FIG. 3, the slave chip 120 detects data needed to be transmitted to the host chip 110 (this may result from changes of the states of the detected signals, and the data needed to be transmitted is the states of these detected signals), and alters the voltage on the request pin pair 130 at t1 for informing the host chip 110 of the data to be transmitted. When the host chip 110 detects the voltage change of the request pin pair 130, the host chip 110 starts to deliver a clock signal via the clock pin pair 160 to the slave chip 120 at t2, and informs the slave chip 120 with a rising edge of the voltage on the latch pin pair 140 to prepare for transmitting data. At t3, the host chip 110 informs the slave chip 120 to start transmitting data with a falling edge of the voltage on the latch pin pair 140. Meanwhile, the slave chip 120 transmits the data sequentially via the data pin pair 140 on the basis of the clock signal. From the point of view of data transmission, the period from t3 to t4 is considered as a first clock cycle, the period from t4 to t5 is considered as a second clock cycle, and so on. Similarly, the period from t15 to t16 is considered as a thirteenth clock cycle. The host chip 110 and the slave chip 120 implement data transmission within these thirteen clock cycles. And the host chip 110 decodes the data received with these thirteen clock cycles on the basis of the clock signal. At t16, these four pin pairs return to the states at t1, and prepare for the next data transmission. It should be noted that the thirteen clock cycles are only an example. In practice, the quantity of the clock cycles depends on the requirements of data transmission and can be modified.

According to the present invention, the multi-chip system 100 can determine the data need to be transmitted in each clock cycle in advance. Take an optical disk drive for example. If the data to be transmitted in the first, second, third, fourth, fifth, and sixth clock cycles are respectively the tracking servo signal, focusing servo signal, tray open signal, tray close signal, disc blank signal, and disc defect signal, the host chip 110 can then obtain the following information: the state of the tracking servo signal is “1”, the state of the focusing signal is “1”, the state of the tray open signal is “1”, the state of the tray close signal is “0”, the state of the disc blank signal is “0”, and the state of the disc defect signal is “1”. In addition, the host chip 110 can record the states of the signals previously received from the slave chip 120, and use a counter and a comparator to determine which signal (or signals) has changed.

In comparison with the prior art method, the slave chip of the present invention actively makes a request for transmitting data, and it is not necessary for the host chip to check the register periodically. Consequently, the resources of the multi-chip system are not wasted. In addition, the present invention uses less pin pairs than the prior art method, and can transmit a plurality of signal sources by means of decoding.

Those skilled in the art will readily appreciate that numerous modifications and alterations of the device may be made without departing from the scope of the present invention. Accordingly, the above disclosure should be construed as limited only by the metes and bounds of the appended claims.

1. A method for transmitting data in a multi-chip system, the multi-chip system comprising at least a host chip and at least a slave chip, the method comprising the following steps:
(a) the slave chip informing the host chip of data needed to be transmitted;
(b) when being informed by the slave chip, the host chip informing the slave chip to start to transmit the data; and
(c) when being informed by the host chip, the slave chip starting to transmit the data to the host chip.

2. The method of claim 1 wherein in step (b) the host chip further delivers a clock signal to the slave chip.

3. The method of claim 1 wherein in step (a) the slave chip actively alters a voltage on a request pin pair, electrically connected between the host chip and the slave chip, to inform the host chip of the data needed to be transmitted.

4. The method of claim 1 wherein in step (a) the slave chip detects states of a plurality of signals, when any changes of the states of the plurality of the signals are detected, the slave chip actively alters a voltage on a request pin pair to inform the host chip of the data needed to be transmitted, wherein the request pin pair is electrically connected between the host chip and the slave chip.

5. The method of claim 1 wherein in step (b) the host chip detects a voltage on a request pin pair, when the host chip detects that the voltage on the request pin pair has changed, the host chip delivers a clock signal to the slave chip via a clock pin pair, wherein the request pin pair and the clock pin pair are both electrically connected between the host chip and the slave chip.

6. The method of claim 1 wherein in step (b) the host chip alters a voltage on a latch pin pair for informing the slave chip to start transmitting the data, wherein the latch pin pair is electrically connected between the host chip and the slave chip.

7. The method of claim 1 wherein in step (c) the slave chip transmits the data to the host chip via a data pin pair on a basis of a clock signal of a clock pin pair, wherein the data pin pair and the clock pin pair are both electrically connected between the host chip and the slave chip.

8. The method of claim 1 wherein in step (c) the slave chip transmits states of a plurality of signals to the host chip via a data pin pair on a basis of a clock signal of a clock pin pair, wherein the data pin pair and the clock pin pair are both electrically connected between the host chip and the slave chip.

9. The method of claim 1 wherein the method further comprises the following step:
(d) the host chip receiving data from the slave chip and decoding the data.
